(19) United States
(12) Patent Application Publication
(10) Pub. No.: US 2022/0193730 A1
(43) Pub. Date: Jun. 23, 2022

(54) ARTICLE SORTING SYSTEM AND METHOD

(71) Applicant: BEIJING KUANGSHI ROBOTICS TECHNOLOGY CO., LTD., Beijing (CN)

(72) Inventors: Liangyou ZHANG, Beijing (CN); Xiaolu FENG, Beijing (CN); Deping CHEN, Beijing (CN)

(21) Appl. No.: 17/611,844

(22) PCT Filed: Aug. 16, 2019
(86) PCT No.: PCT/CN2019/101091

§ 371 Date: Nov. 16, 2021

(30) Foreign Application Priority Data
Jun. 17, 2019 (CN) 201910523820.1

(51) Int. Cl. B07C 3/04; B07C 3/08; B07C 3/12; B07C 3/18

(52) U.S. Cl. CPC B07C 3/04; B07C 3/08; B07C 2301/0008; B07C 3/18; B07C 3/12

(57) ABSTRACT

Disclosed are article sorting system and method. The system comprises a sorting machine, a plurality of container conveyors, and a processor. The processor is used for: determining a target container conveyor and a target container which correspond to article according to article information; controlling the sorting machine to align a first target sorting conveyor with the target container conveyor according to a relative position relationship between the first target sorting conveyor where the article is located on the sorting machine and the target container conveyor; and controlling the first target sorting conveyor to convey the article into the target container of the target container conveyor.

The present application claims the priority to a Chinese patent application No. 201910523820.1, filed on Jun. 17, 2019, the content of which is incorporated herein by reference in entirety as a part of the present application.

### TECHNICAL FIELD

Embodiments of the present disclosure are directed to an article sorting system and method.

### BACKGROUND ART

In express and logistics industries, one of the key links is sorting of articles, specifically comprising classifying, for batches of articles mixed and collected together, the articles according to a rule such as a destination, and collecting various categories of articles for next transportations or dispatches.

At present, a conventional way to sort articles comprises: a sorting person picking up all articles in an order, and dropping an article to a bin corresponding to the article according to information of the article, wherein in case that the bin is full, the full bin can be shipped.

However, in the above solution, sorting the articles needs to be operated manually, resulting in a low efficiency of the sorting operation. Moreover, the manual sorting is mechanical labor taking long hours, which results in a bigger error in sorting and reduces an accuracy of the sorting operation.

### SUMMARY

An embodiment of the present disclosure provides an article sorting system and method for solving the problem of a low efficiency of the sorting operation and a low accuracy of the sorting operation.

To solve the above technical problem, the embodiment of the present invention is implemented as follows.

In a first aspect, an embodiment of the present invention provides an article sorting system which may comprise:

a sorting machine, a plurality of container conveyors, and a processor, wherein a plurality of sorting conveyors are provided along an outer side of the sorting machine, each sorting conveyor is provided corresponding to one container conveyor, and each container conveyor is provided thereon with a plurality of containers;

the processor is configured to:

obtain information of the article;

determine, according to the information of the article, a target container conveyor and a target container which correspond to the article;

control the sorting machine, according to a relative position relationship between the target container conveyor and the first target sorting conveyor where the article is located on the sorting machine, to align a first target sorting conveyor with the target container conveyor; and

control the first target sorting conveyor to convey the article into the target container of the target container conveyor.

In a second aspect, an embodiment of the present invention provides an article sorting method which may comprise:

obtaining information of the article;

determining, according to the information of the article, a target container conveyor and a target container which correspond to the article;

controlling the sorting machine, according to a relative position relationship between the target container conveyor and the first target sorting conveyor where the article is located on the sorting machine, to align a first target sorting conveyor with the target container conveyor; and

controlling the first target sorting conveyor to convey the article into the target container of the target container conveyor.

In a third aspect, an embodiment of the present invention provides a computer-readable storage medium, stored thereon with computer programs which, when executed by a processor, implement the steps of the above article sorting method.

In a fourth aspect, an embodiment of the present invention provides a device comprising a processor, a memory and computer program stored on the memory and operable on the processor, wherein when executed by the processor, the computer programs implement the steps of the above article sorting method.

In an embodiment of the present invention, an article sorting system comprises: a sorting machine, a plurality of container conveyors, and a processor, wherein a plurality of sorting conveyors are provided along an outer side of the sorting machine, each sorting conveyor is provided corresponding to one container conveyor, and each container conveyor is provided thereon with a plurality of containers; the processor is configured to: obtain information of the article; determine, according to the information of the article, a target container conveyor and a target container which correspond to the article; control the sorting machine, according to a relative position relationship between the target container conveyor and the first target sorting conveyor where the article is located on the sorting machine, to align a first target sorting conveyor with the target container conveyor; and control the first target sorting conveyor to convey the article into the target container of the target container conveyor. In the present disclosure, the processor automatically allocates a corresponding target container conveyor and target container for the article according to the information of the article, which implements interaction between the article sorting system and the article information system, achieving the object of automatically sorting while improving the sorting accuracy. Moreover, in the present disclosure, the processor controls the first target sorting conveyor storing temporarily the articles to align with the target container conveyor to which the article is to be dropped, and controls the first target sorting conveyor to convey the article to the target container of the target container conveyor, further improving the accuracy and the automation degree of the sorting operation, and solving the problems of the low sorting efficiency and the poor sorting accuracy due to the manual sorting.

### BRIEF DESCRIPTION OF DRAWINGS

FIG. 1 is a structural block diagram of an article sorting system provided by an embodiment of the present disclosure;

FIG. 2 is a specific structural view of an article sorting system provided by an embodiment of the present disclosure;

FIG. 3 is a flowchart of steps executed by a processor provided by an embodiment of the present disclosure;

FIG. 4 is a specific structural view of a sorting conveyor provided by an embodiment of the present disclosure;

FIG. 5 is a specific structural view of a container conveyor provided by an embodiment of the present disclosure;

FIG. 6 is a view of a relative position relationship between a feeding port of a first target sorting conveyor and a target container conveyor provided by an embodiment of the present disclosure;

FIG. 7 is a flowchart of specific steps executed by a processor provided by an embodiment of the present disclosure;

FIG. 8 is a schematic view of distribution of container placement positions provided by an embodiment of the present disclosure;

FIG. 9 is a schematic view of another distribution of container placement positions provided by an embodiment of the present disclosure;

FIG. 10 is a flowchart of specific steps executed by another processor provided by an embodiment of the present disclosure;

FIG. 11 is a flowchart of specific steps executed by another processor provided by an embodiment of the present disclosure;

FIG. 12 is an assembly structural view of a sorting machine and a feeding conveying belt provided by an embodiment of the present disclosure;

FIG. 13 is a flowchart of specific steps executed by another processor provided by an embodiment of the present disclosure;

FIG. 14 is a flowchart of specific steps executed by another processor provided by an embodiment of the present disclosure;

FIG. 15 is a flowchart of specific steps executed by another processor provided by an embodiment of the present disclosure;

FIG. 16 is an assembly structural top view of a sorting machine and a container rotary table provided by an embodiment of the present disclosure;

FIG. 17 is an assembly structural top view of a container rotary table and a case-replacing conveyor provided by an embodiment of the present disclosure;

FIG. 18 is a flowchart of steps of an article sorting method provided by an embodiment of the present disclosure; and

FIG. 19 is a block diagram of a device provided by an embodiment of the present disclosure.

### DETAILED DESCRIPTION OF THE EMBODIMENTS

The technical solutions of embodiments of the present disclosure will be described clearly and completely with reference to the drawings in the embodiments of the present disclosure. It is apparent that the embodiments described are some, but not all of the embodiments of the present disclosure. All the other embodiments, obtained by those skilled in the art in light of the embodiments of the disclosure without inventive efforts, will fall within the claimed scope of the present disclosure.

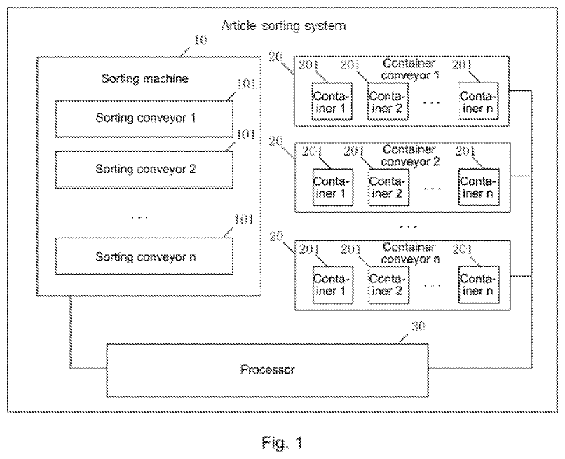

FIG. 1 is a structural block diagram of an article sorting system provided by an embodiment of the present disclosure. As shown in FIG. 1, the system may comprise: a sorting machine 10 comprising a plurality of sorting conveyors 101, a plurality of container conveyors 20 each comprising a plurality of containers 201, and a processor 30, wherein the processor 30 is connected with the sorting machine 10 and the plurality of container conveyors 20 respectively, and the processor 30 is configured to control the sorting machine 10 to drive the sorting conveyor 101 to move, and to control the container conveyor 20 to change a position of the container 201 provided on the container conveyor 20.

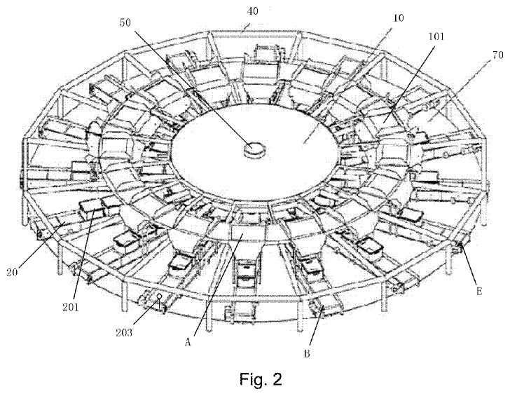

Specifically, referring to FIG. 2, FIG. 2 is a specific structural view of an article sorting system provided by an embodiment of the present disclosure. As shown in FIG. 2, the system may comprise: a sorting machine 10, a plurality of container conveyors 20, and a processor (not shown in FIG. 2), wherein a plurality of sorting conveyors 101 are provided along an outer side of the sorting machine 10, each sorting conveyor 101 is provided corresponding to one container conveyor 20, and each container conveyor 20 is provided thereon with a plurality of containers 201.

In a specific implementation of the embodiment of the present disclosure, referring to FIG. 2 which provides a structure of an article sorting system, the sorting machine 10 may be of an annular structure, a center of the sorting machine 10 may be provided with a drive motor 50, and the processor may control the drive motor 50, so that the sorting machine 10 drives the sorting conveyor 101 to move.

Around a circumference of an annular outer side of the sorting machine 10, a plurality of sets of sorting conveyors 101 are connected, and each sorting conveyor 101 is provided with a corresponding container conveyor 20. The plurality of sets of sorting conveyors 101 and the corresponding plurality of sets of container conveyors 20 may be provided in a radial pattern centering on the sorting machine 10. Moreover, the sorting machine 10 and the plurality of container conveyors 20 may be fixed in terms of position by a bearing bracket 40.

Referring to FIG. 2, for example, a shape of the sorting machine 10 may be an annular shape. In addition, the shape of the sorting machine 10 may also be other shapes which are closed shapes, for example, a rectangle, a diamond shape or the like. When the shape of the sorting machine 10 is a closed shape, the processor may control the drive motor 50 so that the sorting machine 10 rotates by taking the center of the sorting machine 10 as the origin, and drives the sorting conveyor 101 to move.

It should be noted that the shape of the sorting machine 10 may also be a non-closed shape, for example, a U-shape, an L-shape, a straight-line shape, or the like. When the shape of the sorting machine 10 is a non-closed shape, the processor may control the drive motor 50 so that the sorting machine 10 reciprocates, and drives the sorting conveyor 101 to move.

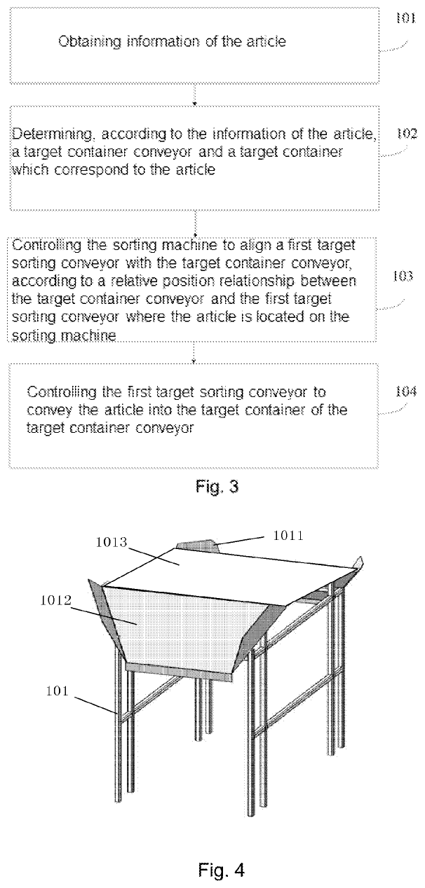

In an embodiment of the present disclosure, referring to FIG. 3, FIG. 3 is a flowchart of steps executed by a processor provided by an embodiment of the present disclosure, wherein the processor is configured to execute the following steps:

Step 101. Obtaining information of the article.

In an embodiment of the present disclosure, in the process of packing the articles, an outer packaging of the article may be attached with an article identification code (for example, a barcode, a two-dimensional code, an one-dimensional code or the like), and information of the article may be obtained by scanning the article identification code with a visual scanning device such as a code scanner, where the information of the article comprises but not limited to article type information of the article and order information to which the article belongs. After obtaining the information of the article, the visual scanning device may send the information of the article to the processor.

In addition, the visual scanning device may be installed in a feeding conveying belt. After an article is dropped to the feeding conveying belt, and the information of the article is obtained by the visual scanning device, the feeding conveying belt may drop the article to a first target sorting conveyor in an idle state in the sorting machine, for a temporary storage.

Step 102. Determining, according to the information of the article, a target container conveyor and a target container which correspond to the article.

In an embodiment of the present disclosure, a corresponding target container conveyor needs to be allocated for a piece of article, and a target container in the target container conveyor to which the article needs to be dropped needs to be determined.

In an implementation of an embodiment of the present disclosure, a corresponding target container conveyor and a target container may be allocated for a list based on the list to which the article belongs among the information of the article, so that all the articles in the list are dropped into the target container of the target container conveyor.

In another implementation of an embodiment of the present disclosure, a target container conveyor and a target container which correspond to a destination may be allocated for the article based on the destination corresponding to the article among the information of the article, so that the article is dropped into the target container of the target container conveyor corresponding to the destination. Of course, a target container conveyor and a target container which correspond to other information may also be allocated for the article based on the other information of the article among the information of the article, where the other information comprises but not limited to article classification of an article, fragileness/non-fragileness of the article, a size of the article, etc.

Step 103. Controlling the sorting machine to align a first target sorting conveyor with the target container conveyor, according to a relative position relationship between the target container conveyor and the first target sorting conveyor where the article is located on the sorting machine.

Referring to FIG. 4, FIG. 4 is a specific structural view of a sorting conveyor provided by an embodiment of the present disclosure, wherein the sorting conveyor 101 may comprise a two-way conveying belt 1013, and a first feeding port 1012 and a second feeding port 1013 respectively provided in two opposite conveying directions of the two-way conveying belt 1013. Through the first feeding port 1012 and the second feeding port 1013, and with the two-way conveying ability of the two-way conveying belt 1013, the sorting conveyor 101 may drop articles on the two-way conveying belt 1013 in two opposite dropping directions. In addition, in some other cases, the sorting conveyor 101 may also be designed by retaining only the first feeding port 1012 or only the second feeding port 1013, and replacing the two-way conveying belt 1013 with a corresponding one-way conveying belt to reduce the number of parts of the sorting conveyor 101 and reduce its production cost.

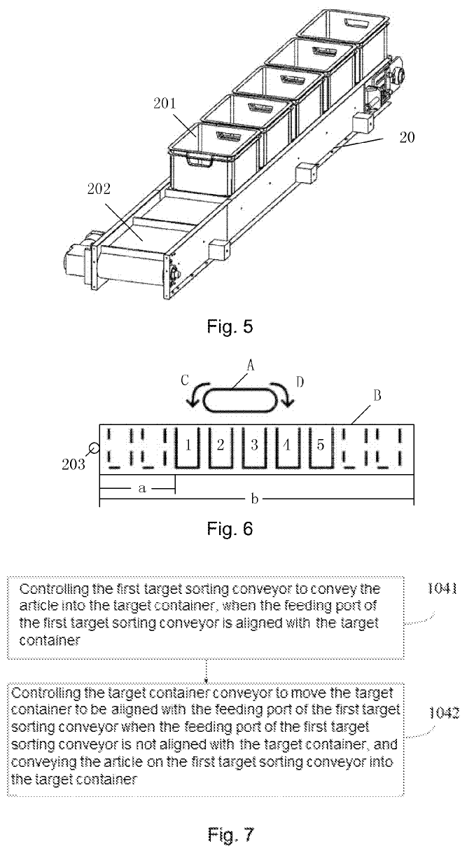

In another implementation of an embodiment of the present disclosure, the sorting conveyor 101 may further comprise a tray or a dumper, and a first feeding port and a second feeding port respectively provided on the tray or the dumper along a radial direction of the sorting machine 10. The tray or the dumper may be controlled to incline in a direction towards the first feeding port or the second feeding port, so that the article placed thereon slides down into a corresponding container below through the first feeding port or the second feeding port. Referring to FIG. 5, FIG. 5 is a specific structural view of a container conveyor provided by an embodiment of the present disclosure, wherein in the container conveyor 20, a plurality of container placement positions 202 arranged side by side may be set by division, and containers 201 with a number less than or equal to that of the container placement positions 202 may be arranged side by side in the container placement positions 202, where the container 201 may be a device that can accommodate an article, for example, a bin, a box, a bag or the like. The processor may control the container conveyor 20 to make the container placement positions 202 changed, achieving the purpose of changing positions of the containers 201 in the container conveyor 20. It should be noted that in practical applications, the number of the container placement positions 202 and the number of the containers 201 may be increased or decreased as actually needed. The embodiment of the present disclosure does not limit the number of the container placement positions 202 and the number of the containers 201.

Specifically, the processor may comprise an encoder. Through the encoder, a relative position relationship between one sorting conveyor and one container conveyor may be detected, and it is determined according to the relative position relationship whether this one sorting conveyor and this one container conveyor are in an alignment state.

If the first target sorting conveyor, where the article is located, on the sorting machine and the target container conveyor are in an alignment state, the processor may perform the operation of step 104 to convey the article to the target container of the target container conveyor.

Referring to FIG. 2, assuming that the article is at the first target sorting conveyor A on the sorting machine and the article needs to be sorted to the target container in the target container conveyor B, in this case, the first target sorting conveyor A and the target container conveyor B are in an unaligned state, then the processor may control the drive motor 50 to drive the sorting machine 10 to move, and to stop when the first target sorting conveyor A is aligned with the target container conveyor B.

It should be noted that in an embodiment of the present disclosure, the path needs to be based on the shortest path principle, with the path for the processor controlling the drive motor 50 to drive the sorting machine 10 to move to make the first target sorting conveyor A move to be aligned with the target container conveyor B. In FIG. 2, if the first target sorting conveyor A is moved to be aligned with the target container conveyor B, the processor may control the drive motor 50 to drive the sorting machine 10 to rotate counterclockwise until the first target sorting conveyor A moves to be aligned with the target container conveyor B. Compared to the case where the processor controls the drive motor 50 to drive the sorting machine 10 to rotate clockwise until the first target sorting conveyor A moves to be aligned with the target container conveyor B, the length of the path corresponding to the counterclockwise rotation is greatly reduced.

Step 104. Controlling the first target sorting conveyor to convey the article into the target container of the target container conveyor.

In an embodiment of the present disclosure, in case that the first target sorting conveyor moves to be aligned with the target container conveyor, the processor needs to further determine whether the feeding port of the first target sorting conveyor is aligned with the target container in the target container conveyor, wherein if they are aligned, the processor may control the conveying belt on the first target sorting conveyor to work directly to drop the article into the target container through the feeding port; if they are not aligned, the processor may control the target container conveyor to move the target container to align with the feeding port of the first target sorting conveyor, and further control the conveying belt on the first target sorting conveyor to work, to drop the article into the target container through the feeding port.

Further, the path needs to be based on the shortest path principle, with the path for the processor controlling the target container conveyor to move the target container to be aligned with the feeding port of the first target sorting conveyor when the feeding port of the first target sorting conveyor is not aligned with the target container in the target container conveyor.

For example, referring to FIG. 6, FIG. 6 is a view of a relative position relationship between a feeding port of a first target sorting conveyor and a target container conveyor provided by an embodiment of the present disclosure, wherein the first target sorting conveyor A may have a feeding port C and a feeding port D which are provided opposite to each other, and a position of the target container conveyor is currently fixed; the target container conveyor B has 9 container placement positions, and 5 containers: a container 1, a container 2, a container 3, a container 4, and a container 5, are arranged side by side in the 9 container placement positions, from the third container placement position counted from the left to the seventh container placement position. If the current target container is the container 5, there are two moving paths for the container 5 moving to be aligned with the feeding port C or the feeding port D. Path 1 is as follows: moving the entire 5 containers to the right by one box, so that the container 5 is aligned with the feeding port D. Path 2 is as follows: moving the entire 5 containers to the left by two boxes, so that the container 5 is aligned with the feeding port C. Based on the shortest path principle, the processor may move the container 5 to be aligned with the feeding port D first according to the path 1.

It should be noted that determining by the processor whether the feeding port of a sorting conveyor is aligned with a container in the container conveyor may comprise providing an identifier (for example, a two-dimensional code, a barcode, a one-dimensional code etc.) comprising an identification of the target container on each target container, and providing a code scanner at the feeding port, in such a way that the identifier is within a scanning range of the code scanner when the feeding port of the sorting conveyor is aligned with the container. In this way, when the feeding port of the first target sorting conveyor is aligned with the target container in the target container conveyor, the code scanner installed at the position of the feeding port of the first target sorting conveyor may determine by scanning the identifier of the target container that the feeding port of the first target sorting conveyor is aligned with the target container in the target container conveyor.

In summary, an article sorting system provided by an embodiment of the present disclosure comprises: a sorting machine, a plurality of container conveyors, and a processor, wherein the plurality of sorting conveyors are provided along an outer side of the sorting machine, each sorting conveyor is provided corresponding to one container conveyor, and each container conveyor is provided thereon with a plurality of containers; the processor is configured to: obtain information of the article; determine a target container conveyor and a target container which correspond to the article according to the information of the article; control the sorting machine to align a first target sorting conveyor with the target container conveyor according to a relative position relationship between the first target sorting conveyor where the article is located on the sorting machine, and the target container conveyor; and control the first target sorting conveyor to convey the article into the target container of the target container conveyor. In the present disclosure, the processor automatically allocates a corresponding target container conveyor and target container for the article according to the information of the article, which implements interaction between the article sorting system and the article information system, achieving the object of automatically sorting on the basis of improving the sorting accuracy. Moreover, in the present disclosure, the processor controls the first target sorting conveyor storing temporarily the articles to be aligned with the target container conveyor to which the article is dropped, and controls the first target sorting conveyor to convey the article to the target container of the target container conveyor, further improving the accuracy and the automation degree of the sorting operation, and solving the problems of low sorting efficiency and poor sorting accuracy caused due to the manual sorting.

Optionally, referring to FIG. 7, FIG. 7 is a flowchart of specific steps executed by a processor provided by an embodiment of the present disclosure, wherein based on Step 104 in the above FIG. 3, the processor is configured to specifically execute the following steps.

Step 1041. Controlling the first target sorting conveyor to convey the article into the target container, when the feeding port of the first target sorting conveyor is aligned with the target container.

In an embodiment of the present disclosure, in case that the first target sorting conveyor moves to be aligned with the target container conveyor, the processor needs to further determine whether the feeding port of the first target sorting conveyor is aligned with the target container in the target container conveyor, and if they are aligned, the processor may control the conveying belt on the first target sorting conveyor to work directly to drop the article into the target container through the feeding port.

Step 1042, Controlling the target container conveyor to move the target container to be aligned with the feeding port of the first target sorting conveyor when the feeding port of the first target sorting conveyor is not aligned with the target container, and conveying the article on the first target sorting conveyor into the target container.

In an embodiment of the present disclosure, in case that the first target sorting conveyor moves to be aligned with the target container conveyor, the processor needs to further determine whether the feeding port of the first target sorting conveyor is aligned with the target container in the target container conveyor, and if they are not aligned, the processor may control the target container conveyor to move the target container to be aligned with the feeding port of the first target sorting conveyor, and further control the conveying belt on the first target sorting conveyor to work, to drop the article into the target container through the feeding port.

Optionally, Step 1042 specifically may comprise:

Step 10421, determining a current position of the target container.

In an embodiment of the present disclosure, in one case, determining a current position of the target container may specifically be determining a position of the target container in the target container conveyor; in another case, determining a current position of the target container may specifically be determining a relative position between the target container and the feeding port.

Optionally, referring to FIG. 2, a distance measuring sensor 203 is provided at an end of a side of the container conveyor 20 facing away from the sorting conveyor 101. Step 10421 may specifically comprise:

Step A1, obtaining through the distance measuring sensor a target separation distance between the distance measuring sensor and the container facing the distance measuring sensor.

In an embodiment of the present disclosure, further referring to FIG. 6, a distance measuring sensor 203 may be provided at an end of a side of the container conveyor facing away from the sorting conveyor. When all the containers stop moving on the container conveyor, the distance measuring sensor 203 may measure a distance a between the distance measuring sensor 203 and the container 1 facing the distance measuring sensor 203.

Step A2, determining a current position of the target container according to the target separation distance.

Optionally, a plurality of container placement positions are set, by division, in the container conveyor, with the plurality of container placement positions being spaced from the end at different separation distances. Step A2 may also be implemented in such a way of determining, as a current position of the target container, a container placement position whose separation distance from the end is the target separation distance.

In an embodiment of the present disclosure, referring to FIG. 6, 9 container placement positions are set, by division, in the container conveyor. Therefore, a total length b of the 9 container placement positions may be known according to a length of each container placement position. Further, according to the distance a obtained in Step A1, it can be known that the distance a is a length that occupies two container placement positions in the total length b, therefore, it can be known that 5 containers: a container 1, a container 2, a container 3, a container 4 and a container 5, are arranged side by side in the 9 container placement positions, from the third container placement position, counted from the left, to the seventh container placement position. In this case, no matter which of the 5 containers the target container is, a specific position of the target container in the 9 container placement positions can be known.

Step 10422. Determining according to the current position of the target container a first path for the target container conveyor moving the target container to be aligned with the feeding port.

Optionally, the first path is a path with the shortest length among a plurality of paths along which the target container is moved to be aligned with the feeding port.

In an embodiment of the present disclosure, in the case where there is only one feeding port of the sorting conveyor, there is only one first path along which the target container conveyor moves the target container to be aligned with the feeding port, and the first path is also the path with the shortest length.

In the case where there are a plurality of feeding ports of the sorting conveyor, a plurality of paths will be generated when one target container is moved to the plurality of different feeding ports. In this case, a first path which is the shortest among the plurality of paths may be selected.

Step 10423. Controlling the target container conveyor according to the first path to move the target container to be aligned with the feeding port.

In this step, in the case where there is only one feeding port of the sorting conveyor, there is only one first path along which the target container conveyor moves the target container to be aligned with the feeding port, and the processor may control the target container conveyor according to the first path to move the target container to be aligned with the feeding port.

In the case where there are a plurality of feeding ports of the sorting conveyor, the processor may control the target container conveyor to move the target container to be aligned with the feeding port, according to the first path which is the shortest among the plurality of paths.

Optionally, referring to FIG. 6, the feeding port comprises a first feeding port C and a second feeding port D respectively located on two sides of the first target sorting conveyor A, where a feeding direction of the first feeding port C is opposite to a feeding direction of the second feeding port D; Step 10422 to Step 10423 may also be specifically implemented through Step B1 to Step B2:

Step B1, controlling the target container conveyor according to a second path to move the target container to be aligned with one of the first feeding port and the second feeding port.

Step B2, the second path is a path with the shortest length among a plurality of paths along which the target container is moved to be aligned with the first feeding port and the second feeding port.

Referring to FIG. 6, the feeding port comprises a first feeding port C and a second feeding port D respectively located on two sides of the first target sorting conveyor A, wherein if the current target container is the container 5, there are two moving paths for moving the container 5 to be aligned with the feeding port C or the feeding port D. Path 1 is as follows: moving the entire 5 containers to the right by one box, so that the container 5 is aligned with the feeding port D. Path 2 is as follows: moving the entire 5 containers to the left by two boxes, so that the container 5 is aligned with the feeding port C. Based on the shortest path principle, the processor may move the container 5 to be aligned with the feeding port D first according to the path 1.

Specifically, an embodiment of the present disclosure may specifically comprise two schemes for dividing the container placement positions. Scheme I is that 5 containers arranged side by side are provided in nine container placement positions arranged side by side. Scheme II is that 5 containers arranged side by side are provided in seven container placement positions arranged side by side.

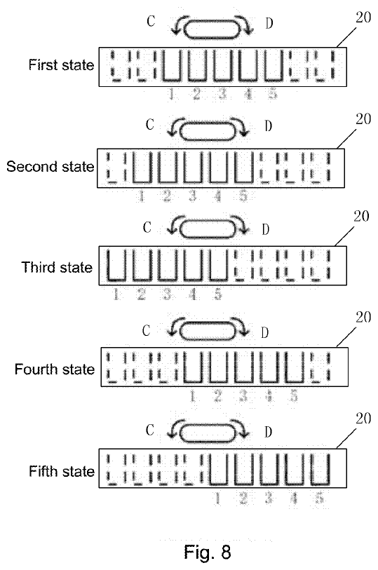

Referring to FIG. 8, regarding Scheme I, nine container placement positions arranged side by side are set, by division, in the container conveyor 20, and five containers arranged side by side are provided in the container placement positions, where, as determined in an order from left to right, the first feeding port C is aligned with the third container placement position among the nine container placement positions, and the second feeding port D is aligned with the sixth container placement position among the nine container placement positions;

when the container on the container conveyor 20 is provided in the container placement position, there are a first state, a second state, a third state, a fourth state, and a fifth state;

in the first state, the five containers are provided at the third container placement position to the seventh container placement position among the nine container placement positions;

in the second state, the five containers are provided at the second container placement position to the sixth container placement position among the nine container placement positions;

in the third state, the five containers are provided at the first container placement position to the fifth container placement position among the nine container placement positions;

in the fourth state, the five containers are provided at the fourth container placement position to the eighth container placement position among the nine container placement positions;

in the fifth state, the five containers are provided at the fifth container placement position to the ninth container placement position among the nine container placement positions;

when the container on the container conveyor 20 is in the first state,
if the target container is the second container or the fifth container among the five containers, the second path is a path for the five containers in the first state moving in a first direction to be in the second state, the first direction being a direction in which the second feeding port D points to the first feeding port C; and
if the target container is the third container among the five containers, the second path is a path for the five containers in the first state moving in a second direction to be in the fourth state, the second direction being a direction in which the first feeding port C points to the second feeding port D;

or, when the container on the container conveyor 20 is in the second state,
if the target container is the first container or the fourth container among the five containers, the second path is a path for the five containers in the second state moving in a second direction to be in the first state, the second direction being a direction in which the first feeding port C points to the second feeding port D; and
if the target container is the third container among the five containers, the second path is a path for the five containers in the second state moving a first direction to be in the third state, the first direction being a direction in which the second feeding port D points to the first feeding port C;

or, when the container on the container conveyor 20 is in the third state,
if the target container is the second container or the fifth container among the five containers, the second path is a path for the five containers in the third state moving in a second direction to be in the second state, the second direction being a direction in which the first feeding port C points to the second feeding port D; and
if the target container is the first container or the fourth container among the five containers, the second path is a path for the five containers in the third state moving in a second direction to be in the first state, the second direction being a direction in which the first feeding port C points to the second feeding port D;

or, when the container on the container conveyor 20 is in the fourth state,
if the target container is the first container or the fourth container among the five containers, the second path is a path for the five containers in the fourth state moving in a first direction to be in the first state, the first direction being a direction in which the second feeding port D points to the first feeding port C;
if the target container is the second container or the fifth container among the five containers, the second path is a path for the five containers in the fourth state moving in a first direction to be in the second state, the first direction being a direction in which the second feeding port D points to the first feeding port C;

or, when the container on the container conveyor 20 is in the fifth state,
if the target container is the first container or the fourth container among the five containers, the second path is a path for the five containers in the fifth state moving in a first direction to be in the first state, the first direction being a direction in which the second feeding port D points to the first feeding port C;
if the target container is the third container among the five containers, the second path is a path for the five containers in the fifth state moving in a first direction to be in the fourth state, the first direction being a direction in which the second feeding port D points to the first feeding port C; and
if the target container is the fifth container among the five containers, the second path is a path for the five containers in the fifth state moving in a first direction to the second state, the first direction being a direction in which the second feeding port D points to the first feeding port C.

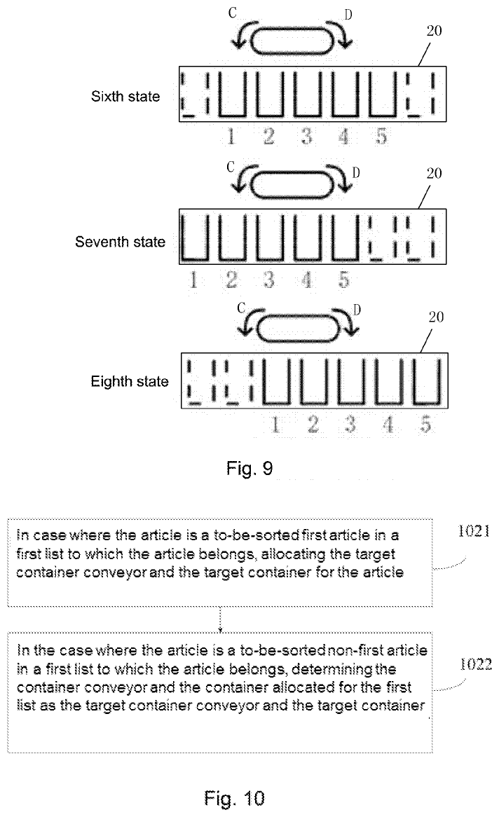

Referring to FIG. 9, regarding Scheme II, seven container placement positions arranged side by side are set, by division, in the container conveyor 20, and five containers arranged side by side are provided in the container placement positions, and the first feeding port C is aligned with the second container placement position among the seven container placement positions, and the second feeding port D is aligned with the fifth container placement position among the seven container placement positions;

when the container on the container conveyor 20 is provided in the container placement position, there are a sixth state, a seventh state, and an eighth state;

in the sixth state, the five containers are provided at the second container placement position to the sixth container placement position among the seven container placement positions;

in the seven state, the five containers are provided at the first container placement position to the fifth container placement position among the seven container placement positions;

in the eighth state, the five containers are provided at the third container placement position to the seventh container placement position among the seven container placement positions;

when the container on the container conveyor 20 is in the sixth state,
if the target container is the second container or the fifth container among the five containers, the second path is a path for the five containers in the sixth state moving in a first direction to be in the seventh state, the first direction being a direction in which the second feeding port D points to the first feeding port C; and
If the target container is the third container among the five containers, the second path is a path for the five containers in the sixth state moving in a second direction to be in the eighth state, the second direction being a direction in which the first feeding port C points to the second feeding port D;

or, when the container on the container conveyor 20 is in the seventh state,
if the target container is the first container or the fourth container among the five containers, the second path is a path for the five containers in the seventh state moving in a second direction to be in the sixth state, the second direction being a direction in which the first feeding port C points to the second feeding port D; and
If the target container is the third container among the five containers, the second path is a path for the five containers in the seventh state moving in a second direction to be in the eighth state, the second direction being a direction in which the first feeding port C points to the second feeding port D;

or, when the container on the container conveyor 20 is in the eighth state,
if the target container is the first container or the fourth container among the five containers, the second path is a path for the five containers in the eighth state moving in a first direction to be in the sixth state, the first direction being a direction in which the second feeding port D points to the first feeding port C; and
if the target container is the second container or the fifth container among the five containers, the second path is a path for the five containers in the eighth state moving in a first direction to be in the seventh state, the first direction being a direction in which the second feeding port D points to the first feeding port C.

Optionally, referring to FIG. 10, FIG. 10 is a flowchart of specific steps executed by a processor provided by an embodiment of the present disclosure, wherein based on Step 102 in the above FIG. 3, the processor is configured to specifically execute the following steps.

Step 1021. In case where the article is a to-be-sorted first article in a first list to which the article belongs, allocating the target container conveyor and the target container for the article.

In an implementation of an embodiment of the present disclosure, in case where the article is a to-be-sorted first article in a first list to which the article belongs, it is indicated that the first list is ready for a sorting operation to be started. Therefore, a processor may allocate for the article a target container conveyor and a target container which correspond to a destination, based on the destination corresponding to the article among the information of the article, so that the article is dropped into the target container of the target container conveyor corresponding to the destination. Of course, a target container conveyor and a target container which correspond to other information may also be allocated for the article based on other information of the article among the information of the article, where other information comprises but not limited to an article classification of an article, fragileness/non-fragileness of the article, a size of the article, etc.

In another implementation of an embodiment of the present disclosure, in case where the article is a to-be-sorted first article in a first list to which the article belongs, it is indicated that the first list is ready for a sorting operation to be started, but a target container conveyor and a target container are not allocated for it yet. Therefore, a processor may allocate for the first list a corresponding target container conveyor and target container, based on the first list to which the article belongs among the information of the article, so that all the articles in the first list are dropped into the target container of the target container conveyor.

In addition, in some cases, if there are a large number of articles in the first list, or the volume of the article is large, in this case it is necessary to allocate for the first list a plurality of target containers, or allocate a plurality of target container conveyors for storing all the articles in the first list. In this case, the target container conveyor and the target container of the article may be any one of the plurality of target container conveyors or the plurality of target containers in the first list.

Optionally, the processor is specifically configured to: allocate, for the article, the target container conveyor and the target container based on the principle of minimum workload.

In an embodiment of the present application, in order to improve the sorting efficiency as far as possible, the processor may allocate for the article the target container conveyor and the target container based on the principle of minimum workload. In terms of being based on the principle of minimum workload, it can be based on the shortest path for the sorting conveyor where article is located moving to the target container conveyor, and the shortest path along which the target container conveyor moves the target container to the feeding port of the sorting conveyor.

Optionally, Step 1021 specifically may comprise:

Step C1, in case where the article is a to-be-sorted first article in a first list to which the article belongs, determining a container conveyor having an empty container.

Referring to FIG. 2, assuming that the container conveyor B and the container conveyor E in the article sorting system have empty containers, the processor may obtain information of the container conveyor B and the container conveyor E.

Step C2, if a plurality of empty container conveyors are comprised, determining a third path for the first target sorting conveyor moving to be aligned with the empty container conveyor, the third path being a path with the shortest length among a plurality of paths for the first target sorting conveyor moving to be aligned with the empty container conveyor.

Further referring to FIG. 2, assuming that the sorting conveyor where the article is currently located is the first target sorting conveyor A, there are four paths for the first target sorting conveyor A moving to be aligned with the container conveyor B or the container conveyor E:

Path 1, controlling the first target sorting conveyor A to rotate clockwise until the first target sorting conveyor A is aligned with the container conveyor B.

Path 2, controlling the first target sorting conveyor A to rotate counterclockwise until the first target sorting conveyor A is aligned with the container conveyor B.

Path 3, controlling the first target sorting conveyor A to rotate clockwise until the first target sorting conveyor A is aligned with the container conveyor E.

Path 4, controlling the first target sorting conveyor A to rotate counterclockwise until the first target sorting conveyor A is aligned with the container conveyor E.

As determined by the length of the path, the length of Path 1>the length of Path 3>the length of Path 4>the length of Path 2 is known. Therefore, the shortest Path 2 can be determined as the third path.

Step C3, allocating the empty container conveyor corresponding to the third path as the target container conveyor for the article.

In this step, referring to FIG. 2, the empty container conveyor B corresponding to the third path may be allocated as the target container conveyor for the article, after the shortest third path is determined. It should be understood that if there are a plurality of third paths, any one of the third paths is allocated as the target container conveyor for the article.

Step C4, determining, as the target container for the article, an empty container distant closest to the feeding port of the first target sorting conveyor in the target container conveyor.

In an embodiment of the present disclosure, the target container conveyor generally has a plurality of containers, and if there are a plurality of containers in the target container conveyor, in case where the first target sorting conveyor is aligned with the target container conveyor, an empty container distant closest to the feeding port of the first target sorting conveyor may be determined as the target container for the article.

In the above, the method for determining the empty container distant closest to the feeding port of the first target sorting conveyor may be specifically referred to the above Step A1 to Step A2, which will not be repeated here.

Step 1022, In the case where the article is a to-be-sorted non-first article in a first list to which the article belongs, determining the container conveyor and the container allocated for the first list as the target container conveyor and the target container.

In an implementation of an embodiment of the present disclosure, in case where the article is a to-be-sorted non-first article in a first list to which the article belongs, it is indicated that the first list is being sorted and a corresponding target container conveyor and target container are already allocated for the first list, and then the article may be dropped into the target container of the target container conveyor.

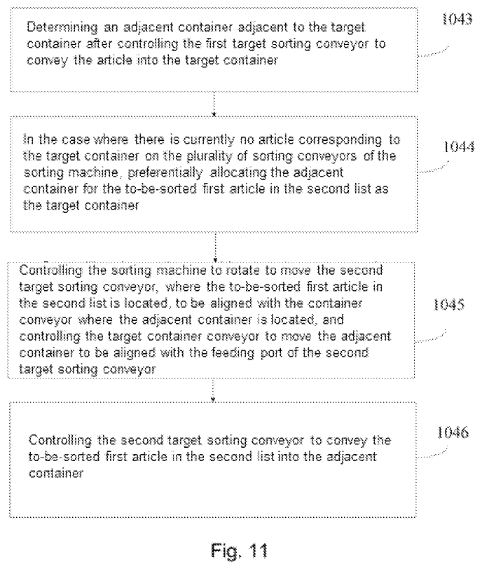

Optionally, referring to FIG. 11, FIG. 11 is a flowchart of specific executed steps of a processor provided by an embodiment of the present disclosure, wherein based on Step 104 in the above FIG. 3, the processor is configured to specifically execute the following steps:

Step 1043. Determining an adjacent container adjacent to the target container after controlling the first target sorting conveyor to convey the article into the target container.

Step 1044, in the case where on the plurality of sorting conveyors of the sorting machine, there is currently no article corresponding to the target container, preferentially allocating the adjacent container for the to-be-sorted first article in the second list as the target container.

Step 1045, controlling the sorting machine to move the second target sorting conveyor where the to-be-sorted first article in the second list is located, to be aligned with the container conveyor where the adjacent container is located, and controlling the target container conveyor to move the adjacent container to be aligned with the feeding port of the second target sorting conveyor.

Step 1046. Controlling the second target sorting conveyor to convey the to-be-sorted first article in the second list into the adjacent container.

In an embodiment of the present disclosure, based on an example of Scheme I as shown in FIG. 8 where nine container placement positions arranged side by side are set, by division, in the container conveyor 20, and five containers arranged side by side are provided in the container placement positions, Step 1043 to Step 1046 are explained.

In case of being in the first state and in case that there is no article to be dropped into the container 1 and the container 4, the container 2 and the container 5 may be determined as adjacent containers, and article dropping demands of the container 2 and the container 5 will be responded preferentially; the container conveyor where container 2 and container 5 are located is allocated for the unsorted second list, as the target container conveyor; the second target sorting conveyor where the to-be-sorted first article in the second list is located is moved to be aligned with the container conveyor where the container 2 and the container 5 are located; the container conveyor where the container 2 and the container 5 are located is controlled to move the container 2 and the container 5 to be aligned with the feeding port of the second target sorting conveyor; and the to-be-sorted first article in the second list is conveyed into the adjacent container. In the case where there is no article to be dropped into the container 2 and the container 5, the demand of the container 3 will be responded.

In short, when containers are at different positions in the container conveyor, corresponding responding levels are as follows:

the first state: the container 1 and the container 4>the container 2 and the container 5>the container 3;

the second state: the container 2 and the container 5>the container 1 and the container 4>the container 3;

the third state: the container 3>the container 2 and the container 5>the container 1 and the container 4;

the fourth state: the container 3>the container 1 and the container 4>the container 2 and the container 5; and

the fifth state: the container 2>the container 3>the container 1 and the container 4>the container 5.

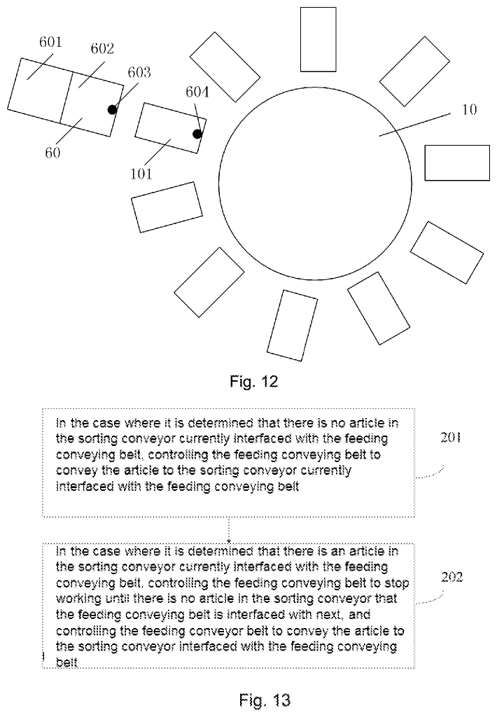

Optionally, referring to FIG. 12, FIG. 12 is an assembly structural view between a sorting machine and a feeding conveying belt provided by an embodiment of the present disclosure, wherein the system further comprises: a feeding conveying belt 60, the feeding conveying belt 60 being configured to be connected with one sorting conveyor 101 of the sorting machine 10.

Further referring to FIG. 13, FIG. 13 is a flowchart of specific steps executed by a processor provided by an embodiment of the present disclosure, the processor is configured to execute the following steps:

Step 201, in the case where it is determined that there is no article in the sorting conveyor currently interfaced with the feeding conveying belt, controlling the feeding conveying belt to convey the article to the sorting conveyor currently interfaced with the feeding conveying belt.

In an implementation, the feeding conveying belt may be consisted of two-end conveying belts, one being a conveying belt 601 where the vision scanning system is located, and the other being a conveying belt 602 that is next to the sorting machine and conveys the article to the sorting machine. Before the conveying belt 601 conveys the article to the conveying belt 602, the processor needs to make a logical judgment to analyze/determine that no article has been dropped to the material position or the dropped article has been successfully dropped into the target container, so as to ensure the material position of the sorting conveyor 101 behind the conveying belt 602 is empty. It should be understood that the feeding conveying belt is not limited to the structure shown in FIG. 12, as long as the requirement for conveying the article to the sorting conveyor 101 can be met.

In the case where the processor determines that the material position of the sorting conveyor 101 behind the conveying belt 602 is empty, the processor may control the feeding conveying belt 60 to convey the article to the sorting conveyor 101 currently interfaced with the feeding conveying belt 60.

Step 202, in the case where it is determined that there is an article in the sorting conveyor currently interfaced with the feeding conveying belt, controlling the feeding conveying belt to stop working until there is no article in the sorting conveyor that the feeding conveying belt is interfaced with next, and controlling the feeding conveyor belt to convey the article to the sorting conveyor interfaced with the feeding conveying belt.

In the case where the processor determines that there is an article in the material position of the sorting conveyor 101 behind the conveying belt 602, the processor may control the sorting machine 10 to move to make the sorting conveyor 101 whose material position has no article move to be aligned with the conveying belt 602, and control the feeding conveying belt 60 to convey the article to a new sorting conveyor 101 interfaced with the feeding conveying belt 60.

The specific article information sent by a sending module of the feeding conveying belt 60 to the processor should comprise the following two items:

(1) a new article flag bit (BOOL): it is a data bit in the internal memory of the processor. Whenever the visual scanning device scans a new article, the sending module of the feeding conveying belt 60 will set this position to True by communicating with the processor; when the processor receives that this signal bit becomes True from False, the processor will know that there is a new product on the conveying belt 601, and in this case the processor must control the conveying belt 601 to stop. The purpose of stopping the conveying belt 601 is to wait for the right time to send the article onto the sorting conveyor.

(2) an identification of the target container: the sending module of the feeding conveying belt 60 transmits the identification of the target container for the article to the processor, and after receiving the article case number, the processor controls the sorting conveyor and the container conveyor to drop the article to a correct target container. The sending module of the feeding conveying belt 60 should set the “new article flag bit” to False when the article leaves the visual scanning device, and set it to True when a new article is scanned.

Optionally, referring to FIG. 12, a photoelectric switch sending end 603 is provided at the end of the feeding conveying belt 60; when the sorting conveyor 101 is interfaced with the feeding conveying belt 60, a photoelectric switch receiving end 604 is provided at an end of the sorting conveyor 101 facing away from the feeding conveying belt 60.

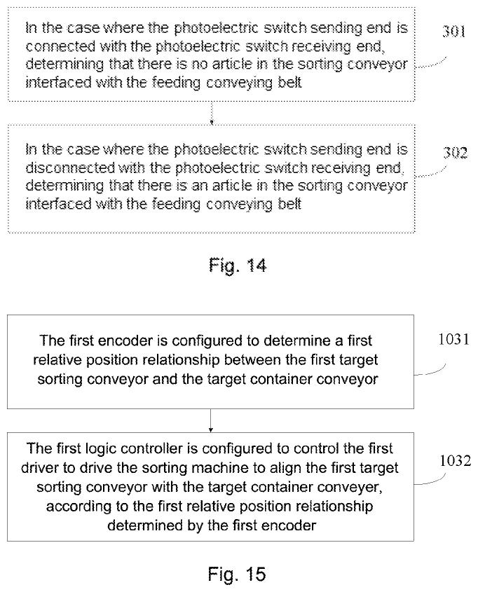

Referring to FIG. 14, FIG. 14 is a flowchart of specific steps executed by a processor provided by an embodiment of the present disclosure, the processor is configured to execute the following steps:

Step 301, in the case where the photoelectric switch sending end is connected with the photoelectric switch receiving end, determining that there is no article in the sorting conveyor interfaced with the feeding conveying belt.

In the case where the photoelectric switch sending end 603 is connected with the photoelectric switch receiving end 604, it is indicated that between the photoelectric switch sending end 603 and the photoelectric switch receiving end 604, there is no obstacle preventing the photoelectric switch sending end 603 from sending a signal to the photoelectric switch receiving end 604, and the processor may determine, based on the above, that there is no article in the sorting conveyor interfaced with the feeding conveying belt.

Step 302, in the case where the photoelectric switch sending end is disconnected with the photoelectric switch receiving end, determining that there is an article in the sorting conveyor interfaced with the feeding conveying belt.

In the case where the photoelectric switch sending end 603 is disconnected with the photoelectric switch receiving end 604, it is indicated that between the photoelectric switch sending end 603 and the photoelectric switch receiving end 604, there is an obstacle preventing the photoelectric switch sending end 603 from sending a signal to the photoelectric switch receiving end 604, and the processor may determine, based on the above, that there is an article in the sorting conveyor interfaced with the feeding conveying belt.

Optionally, the processor comprises a first logic controller and a first encoder; the system further comprises a first driver configured to drive the sorting machine to drive the sorting conveyor to move; and the first driver may be the driver 50 shown in FIG. 2. The first driver may be a servo driver.

Referring to FIG. 15, FIG. 15 is a flowchart of specific steps executed by a processor provided by an embodiment of the present disclosure, wherein based on Step 103 in FIG. 3, the processor is configured to execute the following steps.

Step 1031. The first encoder is configured to determine a first relative position relationship between the first target sorting conveyor and the target container conveyor.

In an embodiment of the present disclosure, referring to FIG. 2, the first logic controller may control, through the first drive, the sorting machine 10 to rotate at a certain speed; and, by taking as an origin a certain point on the circumference around which the sorting machine 10 rotates, the first encoder can measure a rotating angle of the sorting machine 10 based on the origin in real time, and in this way a real-time circumferential position of each sorting conveyor 101 on the sorting machine 10 based on the origin can be calculated. That is, the first encoder may obtain a first relative position relationship between the first target sorting conveyor and the target container conveyor based on this mode.

Optionally, referring to FIG. 2, the system further comprises: a container rotary table 70, and the plurality of container conveyors 20 are provided at a positions corresponding to the plurality of sorting conveyors 101 in the container rotary table 70.

Step 1031 specifically may comprise:

Step 10311, determining a first rotating angle of the target container conveyor based on a first origin, the first origin being a preset origin at a lateral side of the container rotary table.

Step 10312, determining a second rotating angle of the first target sorting conveyor based on a second origin according to the first rotating angle, and determining the second rotating angle as a first relative position relationship between the first target sorting conveyor and the target container conveyor, the second origin being a preset origin, corresponding to the first origin, at a lateral side of the sorting machine.

The second rotating angle is the same as the first rotating angle.

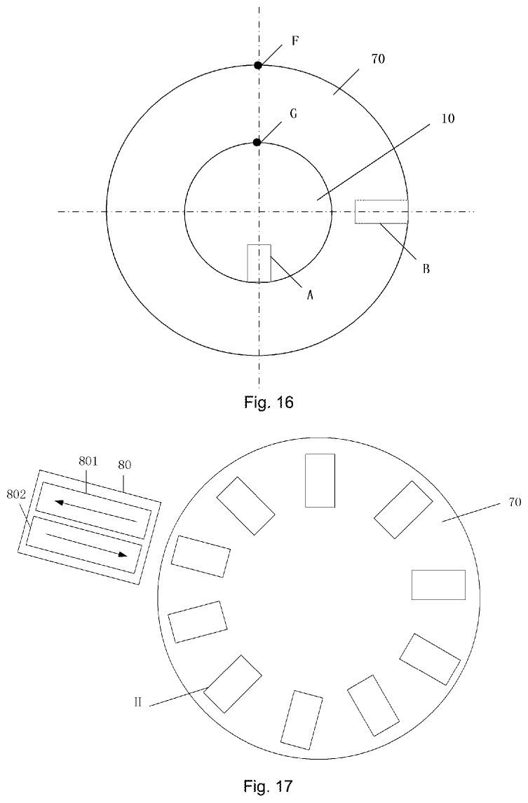

Referring to FIG. 16, FIG. 16 is an assembly structural top view of a sorting machine and a container rotary table provided by an embodiment of the present disclosure, wherein assuming that an outer contour of the sorting machine 10 and an outer contour of the container rotary table 70 are both circular, and the sorting machine 10 and the container rotary table 70 have the same center of circle, a first origin F may be set at the 12 o'clock position of the container rotary table 70; a second origin G may be set at the 12 o'clock position of the sorting machine 10; the first target sorting conveyor A is at the 6 o'clock position of the sorting machine 10; and the target container conveyor B is at the 3 o'clock position of the container rotary table 70.

Then in Step 10311, the first encoder may determine that a first rotating angle of the target container conveyor is 90 degrees based on a first origin. In Step 10312, the first encoder may determine, according to the first rotating angle, that a second rotating angle at which the first target sorting conveyor A moves to be aligned with the target container conveyor B is 90 degrees based on a second origin, and determine the second rotating angle as a first relative position relationship between the first target sorting conveyor A and the target container conveyor B. The first logic controller thus controls the sorting machine 10 to rotate 90 degrees counterclockwise, to align the first target sorting conveyor A with the container conveyor B.

Step 1032. The first logic controller is configured to control, according to the first relative position relationship determined by the first encoder, the first driver to drive the sorting machine to align the first target sorting conveyor with the target container conveyer.

In an embodiment of the present disclosure, the first logic controller may plan out, based on the first relative position relationship determined by the first encoder, two paths (a clockwise rotating path and a counterclockwise rotating path) for the first target sorting conveyor of the sorting machine moving to be aligned with the target container conveyor, and select the shortest path out of the two paths based on the shortest path principle; and according to the shortest path, the first logic controller controls the first driver to drive the sorting machine so that the first target sorting conveyor is aligned with the target container conveyor.

Optionally, referring to FIG. 17, FIG. 17 is an assembly structural top view of a container rotary table and a case-replacing conveyor provided by an embodiment of the present disclosure, wherein the system further comprises: a case-replacing conveyor 80 and a container rotary table 70, and the plurality of container conveyors 20 are provided at positions in the container rotary table 70 corresponding to the plurality of sorting conveyors 101, and the case-replacing conveyor 80 is provided around the container rotary table 70.

The processor is configured to specifically execute the following steps:

Step 401. In the case where there is a container that meets a replacement condition, the container rotary table is controlled to rotate, to align with the case-replacing conveyor a to-be-replaced container conveyor where the container that meets the replacement condition is located, and replace the container that meets the replacement condition with an empty container.

Optionally, if a remaining storage space of a preset number of containers on one container conveyor is less than or equal to a preset threshold, it is determined that there is a container that meets the case-replacing condition.

In an embodiment of the present disclosure, in the case where there is a container that meets a replacement condition, a case-replacing conveyor is needed to perform case-replacing operations on the container that meets a replacement condition, i.e., replacing by controlling the container rotary table the container that meets a replacement condition.

There may be two modes for the processor to determine whether there is a container that meets a replacement condition. Mode 1 is as follows: for one container conveyor, it is deemed that there is a container that meets the case-replacing condition, as long as the processor determines that there is a remaining storage space of a preset number of containers less than or equal to a preset threshold. Mode 2 is as follows: for one container conveyor, it is determined that there is a container that meets the case-replacing condition if the processor determines that remaining storage spaces of all the containers are less than or equal to a preset threshold.

Referring to FIG. 17, assuming it is determined that there is a container that meets a replacement condition on the container conveyor H, the processor controls the container rotary table 70 to rotate, to align with the case-replacing conveyor 80 the to-be-replaced container conveyor H where the container that meets the replacement condition is located, and replace the container that meets the replacement condition with an empty container.

Optionally, the processor comprises a second logic controller and a second encoder; the system further comprises a second driver configured to drive the container rotary table to rotate. The second driver may be a servo driver. The second driver and the first driver may be the same driver, and in addition, the second driver and the first driver may also be different drivers.

Based on Step 401, the second encoder is configured to execute the step:

Step 4011, determining a second relative position relationship between the to-be-replaced container conveyor and the case-replacing conveyor.

Step 4012. The second logic controller is configured to control the second driver according to the second relative position relationship to drive the sorting machine to align the to-be-replaced container conveyor with the case-replacing conveyor.

For details of Step 4011 to Step 4012, please refer to the above Step 1031 to Step 1032, which will not be repeated here.

Optionally, referring to FIG. 17, the case-replacing conveyor 80 comprises a case exiting conveyor 801 and a case entering conveyor 802, the case exiting conveyor 801 and the case entering conveyor 802 being provided around the container rotary table 70.

Step 401 specifically may comprise:

Step 4013, controlling the container rotary table to rotate, to align the to-be-replaced container conveyor with the case exiting conveyor.

Step 4014, controlling the to-be-replaced container conveyor to transmit the container that meets the replacement condition onto the case exiting conveyor.

Step 4015, after the container that meets the replacement condition on the to-be-replaced container conveyor is transmitted to the case exiting conveyor, controlling the container rotary table to rotate to align the to-be-replaced container conveyor with the case entering conveyor.

Step 4016, controlling the case entering conveyor, to transmit a preset number of empty containers onto the to-be-replaced container conveyor.

Referring to Step 17, the processor may control the container rotary table 70 to rotate, to align the to-be-replaced container conveyor H with the case exiting conveyor 801.

After the container that meets the replacement condition on the to-be-replaced container conveyor H is transmitted to the case exiting conveyor 801, the container rotary table 70 is controlled to rotate, to align the to-be-replaced container conveyor H with the case entering conveyor 802, and the case entering conveyor 802 is controlled to transmit the preset number of empty containers onto the to-be-replaced container conveyor H, to complete the case-replacing operation.

In summary, an article sorting system provided by an embodiment of the present disclosure comprises: a sorting machine, a plurality of container conveyors, and a processor, wherein a plurality of sorting conveyors are provided along an outer side of the sorting machine, each sorting conveyor is provided corresponding to one container conveyor, and each container conveyor is provided thereon with a plurality of containers; the processor is configured to: obtain information of the article; determine a target container conveyor and a target container which correspond to the article according to the information of the article; control the sorting machine to align a first target sorting conveyor with the target container conveyor according to a relative position relationship between the first target sorting conveyor where the article is located on the sorting machine, and the target container conveyor; and control the first target sorting conveyor to convey the article into the target container of the target container conveyor. In the present disclosure, the processor automatically allocates a corresponding target container conveyor and target container for the article according to the information of the article, which implements interaction between the article sorting system and the article information system, achieving the object of automatically sorting on the basis of improving the sorting accuracy. Moreover, in the present disclosure, the processor controls the first target sorting conveyor storing temporarily the articles to be aligned with the target container conveyor to which the article is dropped, and controls the first target sorting conveyor to convey the article to the target container of the target container conveyor, further improving the accuracy and the automation degree of the sorting operation, and solving the problem of low sorting efficiency and poor sorting accuracy due to the manual sorting.

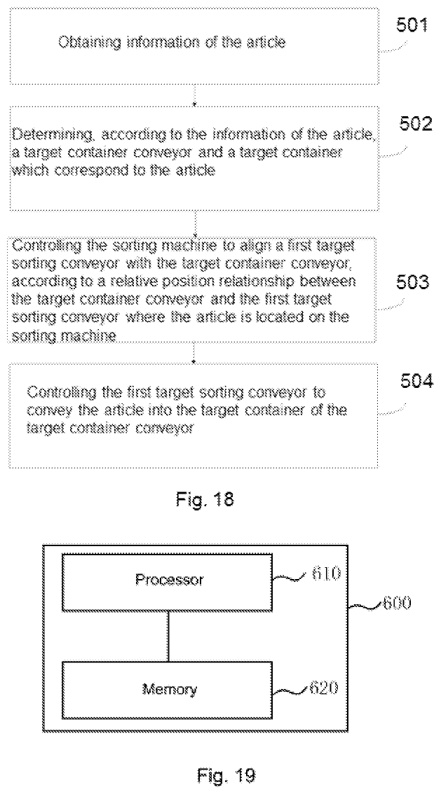

FIG. 18 is a flowchart of steps of an article sorting method provided by an embodiment of the present disclosure, and as shown in FIG. 18, the method may comprise:

Step 501, obtaining information of the article.

For details of this Step, please refer to the above Step 101, which will not be repeated here.

Step 502, determining according to the information of the article a target container conveyor and a target container which correspond to the article.

For details of this Step, please refer to the above Step 102, which will not be repeated here.

Step 503, controlling the sorting machine to align a first target sorting conveyor with the target container conveyor according to a relative position relationship between the target container conveyor and the first target sorting conveyor where the article is located on the sorting machine.

For details of this Step, please refer to the above Step 103, which will not be repeated here.

Step 504, controlling the first target sorting conveyor to convey the article into the target container of the target container conveyor.

For details of this Step, please refer to the above Step 104, which will not be repeated here.

In summary, an article sorting method provided by an embodiment of the present disclosure comprises: obtaining information of the article; determining according to the information of the article a target container conveyor and a target container which correspond to the article; controlling the sorting machine to align a first target sorting conveyor with the target container conveyor according to a relative position relationship between the first target sorting conveyor where the article is located on the sorting machine, and the target container conveyor; and controlling the first target sorting conveyor to convey the article into the target container of the target container conveyor. In the present disclosure, the processor automatically allocates a corresponding target container conveyor and target container for the article according to the information of the article, which implements interaction between the article sorting system and the article information system, achieving the object of automatically sorting on the basis of improving the sorting accuracy. Moreover, in the present disclosure, the processor controls the first target sorting conveyor storing temporarily the articles to be aligned with the target container conveyor to which the article is dropped, and controls the first target sorting conveyor to convey the article to the target container of the target container conveyor, further improving the accuracy and the automation degree of the sorting operation, and solving the problem of low sorting efficiency and poor sorting accuracy due to the manual sorting.

In addition, an embodiment of the present disclosure further provides a device. For details, please refer to FIG. 19. The device 600 comprises a processor 610, a memory 620, and computer programs stored on the memory 620 and operable on the processor 610. When executed by the processor 610, the computer program implements each process of the embodiment of the article sorting method of the foregoing embodiments, where the same technical effect can be achieved. In order to avoid repetition, details are not repeated here.

An embodiment of the present disclosure further provides a computer-readable storage medium stored thereon with computer programs which implements, when executed by a processor, each process of the embodiment of the article sorting system, where the same technical effect can be achieved. In order to avoid repetition, details are not repeated here. The computer-readable storage medium may be a read-only memory (referred to as ROM for short), a random access memory (referred to as RAM for short), a magnetic disk, or an optical disk, etc.

An embodiment of the present disclosure further provides a computer program, which may be stored in a cloud or a local storage medium. When operated by a computer or a processor, the computer program is used to execute the corresponding steps of the article sorting system of the embodiment of the present disclosure, and is used to implement the corresponding modules in the device for establishing a deep learning model according to the embodiment of the present disclosure.

An ordinary skilled in the art can understand that all or part of the steps implementing the foregoing embodiments of the method may be done by a hardware relating to a program instruction. The aforementioned program can be stored in a computer readable storage medium. When executed, the program executes the steps comprising the foregoing embodiments of the method; and the foregoing storage medium comprises: ROM, RAM, magnetic disk, or optical disk, and other media that can store program codes.

Finally, it should be noted that the above embodiments are only used to illustrate the technical solutions of the embodiment of the present disclosure, rather than limiting the same; although the present disclosure has been described in detail with reference to the foregoing embodiments, those of ordinary skill in the art should understand that: It is still possible to modify the technical solutions described in the foregoing embodiments or equivalently replace some or all of the technical features; and these modifications or replacements do not deviate the essence of the corresponding technical solutions from the technical solutions of the embodiments of the present disclosure.

1. An article sorting system, comprising:
a sorting machine, a plurality of container conveyors, and a processor, wherein a plurality of sorting conveyors are provided along an outer side of the sorting machine, each sorting conveyor is provided corresponding to one container conveyor, and each container conveyor is provided thereon with a plurality of containers; and
the processor is configured to:
obtain information of an article;
determine, according to the information of the article, a target container conveyor and a target container which correspond to the article;
control the sorting machine to align a first target sorting conveyor with the target container conveyor, according to a relative position relationship between the target container conveyor and the first target sorting conveyor where the article is located on the sorting machine; and
control the first target sorting conveyor to convey the article into the target container of the target container conveyor.

2. The system according to claim 1, wherein
the processor is configured to:
control the first target sorting conveyor to convey the article into the target container, when a feeding port of the first target sorting conveyor is aligned with the target container; and
control the target container conveyor to move the target container to be aligned with the feeding port of the first target sorting conveyor, when the feeding port of the first target sorting conveyor is not aligned with the target container, and convey the article on the first target sorting conveyor into the target container.

3. The system according to claim 2, wherein
the processor is configured to:
determine a current position of the target container;
determine, according to the current position of the target container, a first path along which the target container conveyor moves the target container to be aligned with the feeding port; and
control, according to the first path, the target container conveyor to move the target container to be aligned with the feeding port.

4. The system according to claim 3, wherein the first path is a path with a shortest length among a plurality of paths for the target container moving to be aligned with the feeding port.

5. The system according to claim 4, wherein the feeding port comprises a first feeding port and a second feeding port respectively located on two sides of the first target sorting conveyor, and a feeding direction of the first feeding port is opposite to a feeding direction of the second feeding port;
the processor is configured to:
control the target container conveyor according to the second path to move the target container to be aligned with one of the first feeding port and the second feeding port; and
the second path is a path with a shortest length among a plurality of paths for the target container moving to be aligned with the first feeding port and the second feeding port.

6. The system according to claim 3, wherein a distance measuring sensor is provided at an end of a side of the container conveyor facing away from the sorting conveyor; and the processor is configured to:
obtain, through the distance measuring sensor, a target separation distance between the distance measuring sensor and a container facing the distance measuring sensor; and
determine the current position of the target container according to the target separation distance.

7. The system according to claim 6, wherein a plurality of container placement positions are set, by division, in the container conveyor, with the plurality of container placement positions being spaced from the end at different separation distances; and
the processor is configured to determine, as a current position of the target container, a container placement position whose separation distance from the end is the target separation distance.

8. The system according to claim 1, wherein
the processor is configured to:
allocate, in case where the article is a to-be-sorted first article in a first list to which the article belongs, the target container conveyor and the target container for the article; and
determine, in case where the article is a to-be-sorted non-first article in the first list to which the article belongs, the container conveyor and the container allocated for the first list as the target container conveyor and the target container.

9. The system according to claim 8, wherein the processor is configured to:
allocate the target container conveyor and the target container for the article based on a principle of minimum workload.

10. The system according to claim 9, wherein the processor is configured to:
determine, in case where the article is the to-be-sorted first article in the first list to which the article belongs, a container conveyor having an empty container;
determine, if a plurality of empty container conveyors are comprised, a third path for the first target sorting conveyor moving to be aligned with the empty container conveyor, the third path being a path with a shortest length among a plurality of paths for the first target sorting conveyor moving to be aligned with the empty container conveyor;
allocate the empty container conveyor corresponding to the third path as the target container conveyor of the article; and
determine, as the target container of the article, an empty container distant closest to the feeding port of the first target sorting conveyor in the target container conveyor.

11. The system according to claim 1, wherein the processor is further configured to:
determine an adjacent container adjacent to the target container after controlling the first target sorting conveyor to convey the article into the target container;
preferentially allocate, in the case where there is currently no article corresponding to the target container on the plurality of sorting conveyors of the sorting machine, the adjacent container for a to-be-sorted first article in the second list as the target container;
control the sorting machine to move a second target sorting conveyor where the to-be-sorted first article in the second list is located, to be aligned with the container conveyor where the adjacent container is located, and control the target container conveyor to move the adjacent container to be aligned with a feeding port of the second target sorting conveyor; and
control the second target sorting conveyor to convey the to-be-sorted first article in the second list into the adjacent container.

12. The system according to claim 1, wherein the system further comprises a feeding conveying belt which is configured to be connected with one of the sorting conveyors of the sorting machine;
the processor is configured to:
control, in the case where it is determined that there is no article in the sorting conveyor currently interfaced with the feeding conveying belt, the feeding conveying belt to convey the article to the sorting conveyor currently interfaced with the feeding conveying belt; and
control, in the case where it is determined that there is an article in the sorting conveyor currently interfaced with the feeding conveying belt, the feeding conveying belt to stop working until there is no article in the sorting conveyor that the feeding conveying belt is interfaced with next, and control the feeding conveyor belt to convey article to the sorting conveyor interfaced with the feeding conveying belt.

13. The system according to claim 12, wherein a photoelectric switch sending end is provided at an end of the feeding conveying belt; when the sorting conveyor is interfaced with the feeding conveying belt, a photoelectric switch receiving end is provided at an end of the sorting conveyor facing away from the feeding conveying belt;
the processor is configured to:
determine, in the case where the photoelectric switch sending end is connected with the photoelectric switch receiving end, that there is no article in the sorting conveyor interfaced with the feeding conveying belt; and
determine, in the case where the photoelectric switch sending end is disconnected with the photoelectric switch receiving end, that there is an article in the sorting conveyor interfaced with the feeding conveying belt.

14. The system according to claim 1, wherein the processor comprises a first logic controller and a first encoder; the system further comprises a first driver configured to drive the sorting machine to drive the sorting conveyor to move;
the first encoder is configured to determine a first relative position relationship between the first target sorting conveyor and the target container conveyor; and
the first logic controller is configured to control, according to the first relative position relationship determined by the first encoder, the first driver to drive the sorting machine to align the first target sorting conveyor with the target container conveyor.

15. The system according to claim 14, wherein the system further comprises: a container rotary table, wherein the plurality of container conveyors are provided at positions in the container rotary table corresponding to the plurality of sorting conveyors;
the first encoder is configured to:
determine a first rotating angle of the target container conveyor based on a first origin, the first origin being a preset origin at a lateral side of the container rotary table;
determine, according to the first rotating angle, a second rotating angle of the first target sorting conveyor based on a second origin, and determine the second rotating angle as a first relative position relationship between the first target sorting conveyor and the target container conveyor, the second origin being a preset origin corresponding to the first origin and being at a lateral side of the sorting machine; and
the second rotating angle is same as the first rotating angle.

16. The system according to claim 1, wherein the system further comprises: a case-replacing conveyor and a container rotary table, the plurality of container conveyors are provided at positions in the container rotary table corresponding to the plurality of sorting conveyors, and the case-replacing conveyor is provided around the container rotary table;
the processor is configured to:
control, in the case where there is a container that meets a replacement condition, the container rotary table to rotate to align with the case-replacing conveyor a to-be-replaced container conveyor where the container that meets the replacement condition is located, and replace the container that meets the replacement condition with an empty container.

17. (canceled)

18. The system according to claim 16, wherein the processor comprises a second logic controller and a second encoder; the system further comprises a second driver configured to drive the container rotary table to rotate;
the second encoder is configured to determine a second relative position relationship between the to-be-replaced container conveyor and the case-replacing conveyor; and
the second logic controller is configured to control the second driver according to the second relative position relationship to drive the sorting machine to align the to-be-replaced container conveyor with the case-replacing conveyor.

19. The system according to claim 16, wherein
the case-replacing conveyor comprises a case entering conveyor and a case exiting conveyor, the case entering conveyor and the case exiting conveyor being provided around the container rotary table; and
the processor is configured to:
control the container rotary table to rotate, to align the to-be-replaced container conveyor with the case exiting conveyor;
control the to-be-replaced container conveyor to transmit the container that meets the replacement condition onto the case exiting conveyor;
control, after the container that meets the replacement condition on the to-be-replaced container conveyor is transmitted onto the case exiting conveyor, the container rotary table to rotate, to align the to-be-replaced container conveyor with the case entering conveyor; and
control the case entering conveyor to transmit a preset number of empty containers onto the to-be-replaced container conveyor.

20. An article sorting method applicable to the article sorting system according to claim 1, wherein the method comprises:
obtaining information of the article;
determining according to the information of the article a target container conveyor and a target container which correspond to the article;
controlling the sorting machine to align a first target sorting conveyor with the target container conveyor, according to a relative position relationship between the target container conveyor and the first target sorting conveyor where the article is located on the sorting machine; and
controlling the first target sorting conveyor to convey the article into the target container of the target container conveyor.

21. (canceled)

22. A device, comprising a processor, a memory and computer programs stored on the memory and operable on the processor, wherein when executed by a processor, the computer programs implement steps of the article sorting method according to claim 20.
